(19) United States
(12) Patent Application Publication
(10) Pub. No.: US 2014/0340823 A1
(43) Pub. Date: Nov. 20, 2014

(54) ELECTRONIC DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: XUE-DONG TANG, Shenzhen (CN); WEI LIU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/279,433

(22) Filed: May 16, 2014

(30) Foreign Application Priority Data
May 17, 2013 (CN) 2013101827093

(51) Int. Cl. G06F 1/16

(52) U.S. Cl. CPC G06F 1/1635; G06F 1/1626
USPC 361/679.3

(57) ABSTRACT

An exemplary electronic device includes a housing, a display unit, a fixing assembly, and a battery. The fixing assembly is arranged in the housing and defines an opening. The fixing assembly further includes a main body and a resisting member. The display unit is arranged on the main body. The resisting member protrudes from a side of the opening and extends toward the opening. The base of the resisting member is flush with the main body. The battery is fixed below the fixing assembly and opposite to the opening. The resisting member and the display unit via the opening resist the battery.

### FIELD

The present disclosure relates to electronic devices, and particularly, to a thin electronic device.

### BACKGROUND

Electronic devices, such as tablet computers, play an important role in our lives. A common electronic device includes a display unit, a fixing assembly, and a battery. The battery and the display unit are separated by the fixing assembly and are located at different sides of the fixing assembly. Thus, the common electronic device is thick.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an electronic device, in accordance with an exemplary embodiment.

FIG. 2 is an exploded view of the electronic device of FIG. 1.

FIG. 3 is similar to FIG. 2, but viewing from another perspective.

FIG. 4 is a cross-sectional view taken along line IV-IV of FIG. 1.

### DETAILED DESCRIPTION

The embodiments of the present disclosure are now described in detail, with reference to the accompanying drawings.

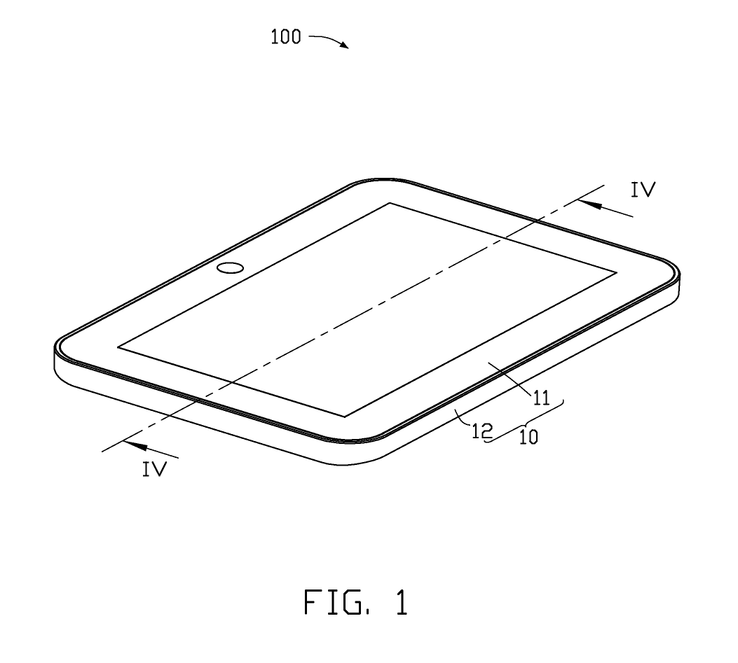

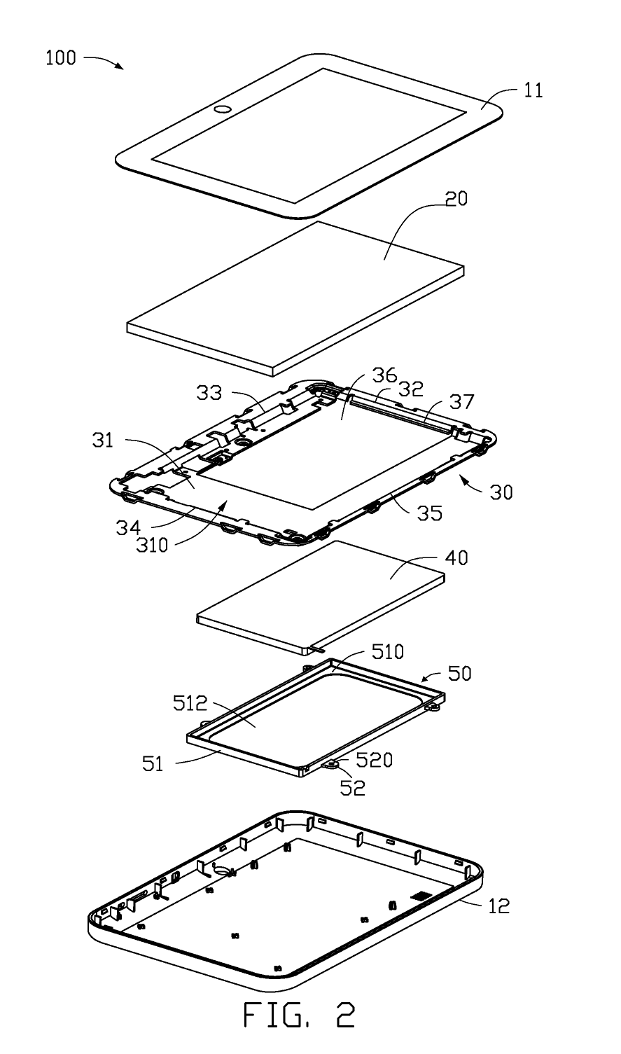

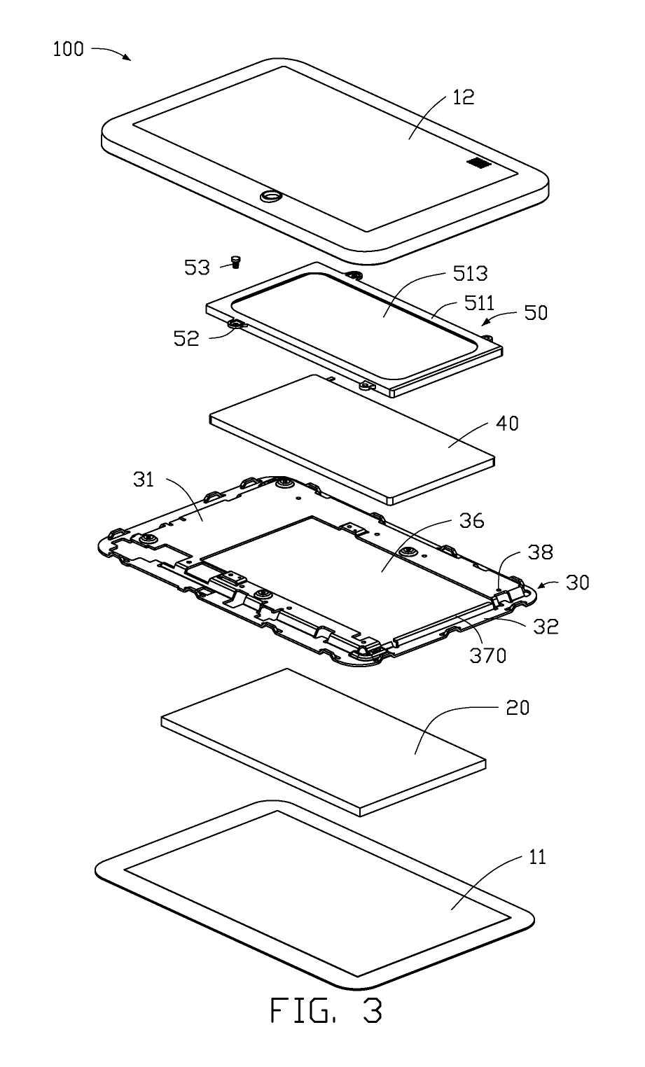

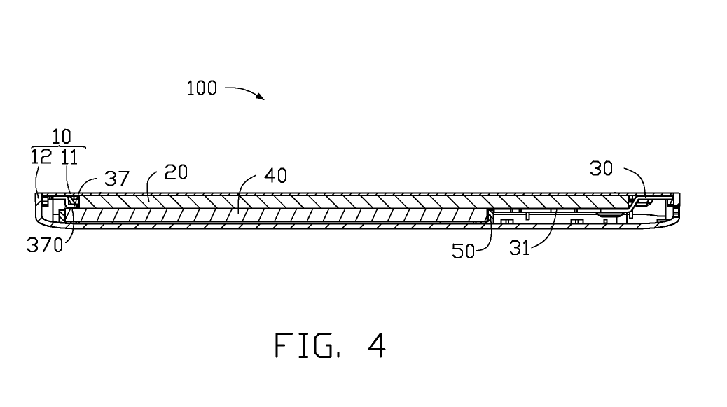

FIGS. 1-4 show an embodiment of an electronic device 100. The electronic device 100 can include a housing 10, a display unit 20, a fixing assembly 30, a battery 40, and a positioning assembly 50. The display unit 20, the fixing assembly 30, the battery 40, and the positioning assembly 50 are received in the housing 10 in sequence from top to bottom. The fixing assembly 30 is used to fix the position of the display unit 20. The positioning assembly 50 is fixed in the housing 10 and is also fixed to the fixing assembly 30. The positioning assembly 50 further cooperates with the fixing assembly 30 to position the battery 40.

The housing 10 includes a first casing 11 and a second casing 12. The first casing 11 is attached to the second casing 12. The second casing 12 cooperates with the first casing 11 to define a receiving space, to receive the display unit 20, the fixing assembly 30, the battery 40, the positioning assembly 50, and electronic components of the electronic device 100.

The fixing assembly 30 includes a main body 31 and four supporting members. The four supporting members are a first supporting member 32, a second supporting member 33, a third supporting member 34, and a fourth supporting member 35. The first supporting member 32, the second supporting member 33, the third supporting member 34, and the fourth supporting member 35 respectively protrude from one side of the main body 31 and cooperatively surround the main body 31. The main body 31 and the supporting members 32-35 cooperatively define a receiving room 310 to receive the display unit 20. The fixing assembly 30 defines an opening 36 extending from the first supporting member 32 to the main body 31. The fixing assembly 30 further includes a resisting member 37. The resisting member 37 protrudes from the first supporting member 32 and extends toward the opening 36. A base 370 of the resisting member 37 is flush with the main body 31. The resisting member 37 is used to resist the battery 40 to limit the position of the battery 40, when the battery 40 is received in the opening 36. In the embodiment, the shape of the resisting member 37 is L-shaped. A bottom 320 of the main body 31 further defines a number of fixing holes 38.

The positioning assembly 50 is attached to the second casing 12. In the embodiment, the size of the positioning assembly 50 is less than the size of the fixing assembly 30. The positioning assembly 50 includes a plate 51, a number of positioning members 52, and a number of fixing members 53. The plate 51 includes a top surface 510 and a bottom surface 511 opposite to the top surface 510. The plate 51 defines a groove 512 opposite to the opening 36 at the top surface 510 and defines a recessed portion 513 at the bottom surface 511 of the plate 51. The size of the groove 512 is less than or equal to the size of the opening 36. The battery 40 is partly received in the groove 512 and partly external of the groove 512. Thus, when the fixing assembly 30 is fixed to the positioning assembly 50, the battery 40 received in the groove 512 is partly received in the opening 36 and physically contacting the display unit 20 received in the receiving room 310. In the embodiment, the battery 40 can be adhered in the groove 512. The recessed portion 513 is used to provide room for the battery 40 and dissipate heat of the battery 40 when the size of the battery 40 increases because of the heat expansion. Each positioning member 52 protrudes from sides of the plate 51 and is opposite to one fixing hole 38. In the embodiment, the positioning members 52 are evenly distributed on the sides of the plate 51. Each positioning member 52 defines a positioning hole 520. Each fixing member 53 passes through one positioning hole 520 and is fixed in the corresponding fixing hole 38, thus the fixing assembly 30 is fixed to the positioning assembly 50. A space remains in the second casing 12 excluding the fixing assembly 30 and the positioning assembly 50, and the electronic components of the electronic device 100 can be fixed in the space of the second casing 12.

When assembling the electronic device 100, the battery 40 is placed in the groove 512 of the positioning assembly 50, each fixing member 53 is pushed to extend through one positioning hole 520 and to be fixed in the corresponding fixing hole 38, thus the fixing assembly 30 is fixed to the positioning assembly 50. Simultaneously, the battery 40 is partly received in the opening 36 and the resisting member 37 of the fixing assembly 30 resists the battery 40 to be limited in the groove 512. Then, the display unit 20 is placed on the main body 31 and surrounded by the supporting members 32-35, thus the battery 40 resists and physically contacts the display unit 20 via the opening 36. In that way, the distance between the display unit 20 and the battery 40 is zero, which reduces the thickness of the electronic device 100.

Although the present disclosure has been specifically described on the basis of the exemplary embodiment thereof, the disclosure is not to be construed as being limited thereto. Various changes or modifications may be made to the embodiment without departing from the scope of the disclosure or that of the following claims.

What is claimed is:

1. An electronic device comprising:
a housing;
a display unit;
a fixing assembly arranged in the housing and defining an opening, the fixing assembly further comprising a main body and a resisting member, the display unit being arranged on the main body, the resisting member protruding from a side of the opening and extending toward the opening, the base of the resisting member being flush with the main body; and
a battery fixed below the fixing assembly and substantially opposite to the opening, the battery being resisted by the resisting member and resisted by the display unit via the opening.

2. The electronic device as described in claim 1, wherein the fixing assembly further comprises a first supporting member, a second supporting member, a third supporting member, and a fourth supporting member; the first supporting member, the second supporting member, the third supporting member, and the fourth supporting member respectively protrude from one side of the main body and cooperatively surround the main body; the display unit is received in a receiving room formed by the main body, the first supporting member, the second supporting member, the third supporting member, and the fourth supporting member; the opening extending from the first supporting member to the main body, and the resisting member protrudes from the first supporting member.

3. The electronic device as described in claim 1, wherein the shape of the resisting member is substantially L-shaped.

4. The electronic device as described in claim 1 further comprising a positioning assembly, wherein the positioning assembly is fixed in the housing, the positioning assembly comprises a plate, the plate defines a groove, the battery is resisted by the resisting member to be partly limited in the groove.

5. The electronic device as described in claim 4, wherein the size of the groove is less than or equal to the size of the through groove, and the battery is at least partly external of the groove.

6. The electronic device as described in claim 4, wherein the battery is adhered in the groove.

7. The electronic device as described in claim 4, wherein the plate comprises a top surface and a bottom surface opposite to the top surface, the groove is defined in the top surface and is opposite to the opening, the plate further defines a recessed portion at the bottom surface, the recessed portion is configured to provide room for the battery and dissipate heat of the battery when the size of the battery increases.

8. The electronic device as described in claim 4, wherein the bottom of the main body defines a plurality of fixing holes, the positioning assembly includes a plurality of positioning members and a plurality of fixing members; each of the positioning members protrudes from sides of the plate and is opposite to one of the fixing holes, each of the positioning members defines a positioning hole, each of the fixing members passes through one of the positioning holes and is fixed in the corresponding fixing hole, to fix the fixing assembly to the positioning assembly.
